(19) United States
(12) Patent Application Publication
(10) Pub. No.: US 2008/0270665 A1
(43) Pub. Date: Oct. 30, 2008

(54) Electronic device docking system

(76) Inventors: Mark D. Senatori, Houston, TX (US); William A. Gralewski, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/799,215

(22) Filed: Apr. 30, 2007

(51) Int. Cl. G06F 13/00; G06F 3/041

(52) U.S. Cl. 710/303; 345/173

(57) ABSTRACT

An electronic device docking system, comprising an electronic device having a touch pad and a recessed area, the touch pad and recessed area disposed on a working surface of the electronic device, the recessed area configured to receive an input device.

### BACKGROUND

Electronic devices, such as laptop or notebook computers, utilize detachable input devices. For example, some notebook computers comprise detachable touchpads to provide input commands to the electronic device. However, if the detachable touchpad should become lost or misplaced, providing input to the electronic device is made difficult or may even be impossible.

### BRIEF DESCRIPTION OF THE DRAWINGS

FIG. 1 is a diagram of an electronic device employing an embodiment of a docking system to advantage for an input device; and

FIG. 2 is a diagram illustrating the bottom of the input device of FIG. 1.

### DETAILED DESCRIPTION OF THE DRAWINGS

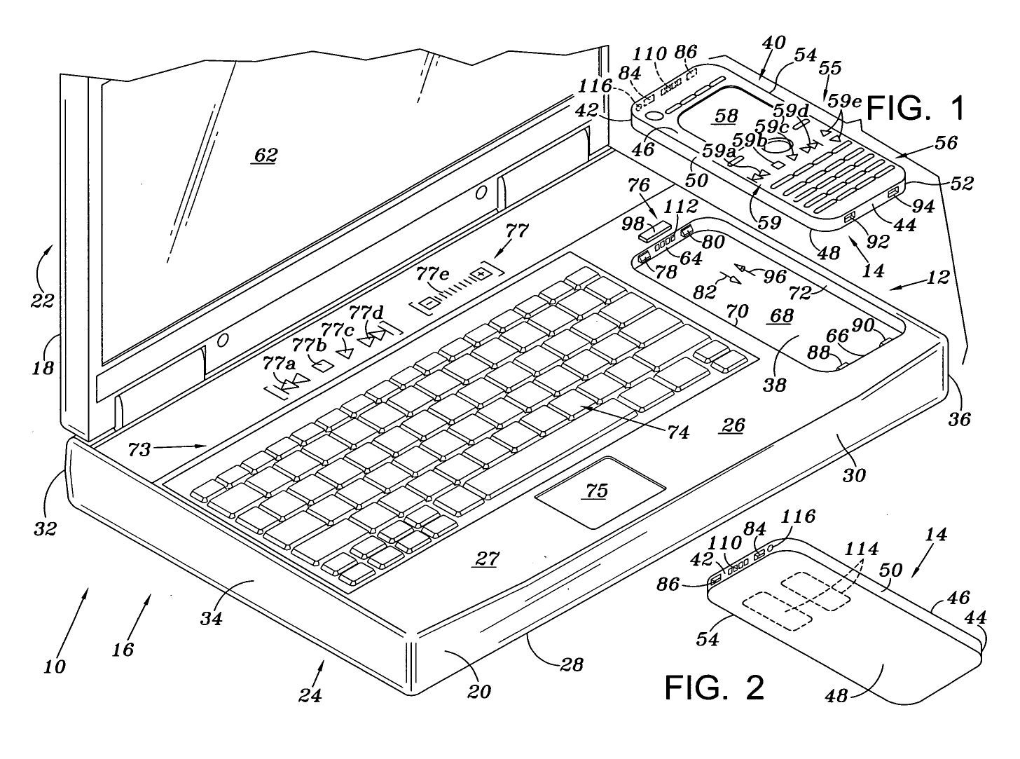

Various embodiments and the advantages thereof are best understood by referring to FIGS. 1 and 2 like numerals being used for like and corresponding parts of the various drawings.

FIG. 1 is a diagram illustrating an electronic device 10 in which an embodiment of a docking system 12 is employed to advantage to receive a detachable input device 14. In the embodiment illustrated in FIG. 1, electronic device 10 comprises a laptop or notebook computer 16; however, it should be understood that electronic device 10 may comprise any type of electronic device such as, but not limited to, a tablet personal computer, a personal digital assistant, a gaming device, or any other type of portable or non-portable electronic device. In the embodiment illustrated in FIG. 1, electronic device 10 comprises a display member 18 rotatably coupled to a base member 20. Display member 18 and base member 20 each comprise a housing 22 and 24, respectively, formed having a number of walls. For example, housing 22 comprises a top wall 26 forming a working surface 27, a bottom wall 28, a front wall 30, a rear wall 32 and a pair of sidewalls 34 and 36. In the embodiment illustrated in FIG. 1, top wall 26 comprises a plurality of input interfaces 73 comprising an alphanumeric keyboard 74, a touchpad 75 and a plurality of media input buttons 77. Media input buttons 77 may be used to provide input and/or otherwise control the presentation and/or output of various types of media entered such as, but not limited to, a compact disk (CD), a digital video disk (DVD) streaming content, etc. In the embodiment illustrated in FIG. 1, media input buttons 77 comprise a review button 77a, a stop button 77b, a play button 77c, a skip forward button 77d and a volume control 77e.

In the embodiment illustrated in FIG. 1, docking system 12 comprises a recessed area 38 disposed on top wall 26 and configured to receive and/or otherwise store input device 14. In the embodiment illustrated in FIG. 1, input device 14 comprises a housing 40 having walls 42, 44, 46, 48, 50 and 52. In FIG. 1, input device 14 comprises a remote control 54 having plurality of input interfaces 55 such as an alphanumeric keypad 56 functioning similar to keyboard 74, a touch pad 58 to facilitate positioning of a cursor on a display screen 62 of display member 18, and a plurality of media input buttons 59. In the embodiment illustrated in FIG. 1, media input button 59 comprise a review button 59a, a stop button 59b, a play button 59c, a skip forward button 59d and a volume control button 59e disposed on top wall 46. It should be understood, however, that input device 14 may be any type of device other than a remote control 54 such as, but not limited to, a gaming device, or a personal data assistant. In the embodiment illustrated in FIG. 1, keypad 56, touch pad 58 and media input buttons 59 disposed on input device 14 may be used in addition to or in lieu of keyboard 74, touchpad 75 and media input buttons 77 disposed on top wall 26. Accordingly, input device 14 provides a plurality of different types of input interfaces 55 which may be used in addition to or in lieu of input interfaces 73 available on electronic device 10 so that even if input device 14 becomes lost, stolen and/or is otherwise unusable, at least some of the various types of input interfaces 55 provided by input device 14 remain available for use on electronic device 10.

In the embodiment illustrated in FIG. 1, recessed area 38 is formed by walls 64, 66, 68, 70 and 72. According to some embodiments, recessed area 38 is sized such that wall 46 of input device 14 is flush (flush or substantially flush) with top wall 26 of electronic device 10 when input device 14 is disposed in recessed area 38 to enable input device 14 to be disposed within recessed area 38 while electronic device 10 is in the closed position. It should be understood that input device 14 may also reside in recessed area 38 in a non-flush condition (e.g., such that a recess or other area in display member 18 receives at least a portion of input device 14 when electronic device 10 is in a closed position). As used herein, a “closed position” of electronic device 10 shall mean when display member 18 is located in a position substantially parallel and/or coplanar with base member 20 such that display member 18 is disposed in contact with or directly adjacent to top wall 26 of electronic device 10. Furthermore, in the embodiment illustrated in FIG. 1, recessed area 38 is disposed on top wall 26 adjacent to keyboard 74 to enable input device 14 to be readily available/usable to a user when disposed within recessed area 38. For example, in the embodiment illustrated in FIG. 1, recessed area 38 is disposed on top wall 26 near or otherwise adjacent to sidewall 36; however, it should be understood that top wall 26 may be otherwise configured such that recessed area 38 is near or otherwise adjacent to sidewall 34, front wall 30 and/or rear wall 32. It should be understood that electronic device 10 may be otherwise configured such that recessed area 38 is disposed within display member 18. In the embodiment illustrated in FIG. 1, input device 14 is operable while disposed within recessed area 38 or, in the alternative, input device 14 is operable while detached from recessed area 38 (e.g., operating based on power provided by electronic device 10 via an extendable cable and/or based on an internal power supply).

In the embodiment illustrated in FIG. 1, docking system 12 comprises a locking mechanism 76 configured to secure input device 14 to electronic device 10. In the embodiment illustrated in FIG. 1, locking mechanism 76 releasably secures input device 14 to electronic device 10 in response to insertion of input device 14 within recessed area 38. In FIG. 1, locking mechanism 76 comprises a pair of extendable and retractable extensions 78 and 80 disposed on wall 64 and outwardly biased in the direction of arrow 82 to engage a pair of corresponding recesses 84 and 86 disposed on wall 42 of input device 14. Locking mechanism 76 further comprises a pair of extensions 88 and 90 extending outwardly from wall 66 configured for insertion within pair of corresponding recesses 92 and 94 disposed on wall 44 of input device 14. It should be understood that locking mechanism 76 may be otherwise configured (e.g., by providing a greater or fewer number of extensions 78, 80, 88 and/or 90, by frictional engagement between input device 14 and recessed area 38, by detents, etc.).

In operation, to couple input device 14 to electronic device 10, recesses 92 and 94 on input device 14 are aligned with extensions 88 and 90 on wall 66 of recessed area 38 to enable insertion of extensions 88 and 90 within recesses 92 and 94. Once extensions 88 and 90 are inserted within corresponding recesses 92 and 94, input device 14 is positioned such that recesses 84 and 86 on wall 64 of input device 14 are otherwise aligned to receive retractable extensions 78 and 80 on wall 64 of recessed area 38. For example, as input device 14 is inserted within recessed area 38, wall 42 of input device 14 contacts extensions 78 and 80 and otherwise pushes/retracts extensions 78 and 80 inward in the direction of arrow 96 until recesses 84 and 86 are aligned with extensions 78 and 80, respectively. Once aligned, extensions 78 and 80 extend in the direction of arrow 82 for insertion within recesses 84 and 86. To unlock locking mechanism 76 and remove input device 14 from recessed area 38, an eject button 98 is depressable so as to retract extensions 78 and 80 from corresponding recesses 84 and 86. Once retracted, input device 14 is removable from recessed area 38.

FIG. 2 is a diagram illustrating a bottom side of input device 14 of FIG. 1. In the embodiment illustrated in FIG. 2, input device 14 comprises a connector 110 for communicative engagement with a corresponding connector 112 disposed within recessed area 38 (FIG. 1). Connectors 110 and 112 enable input device 14 to communicate with electronic device 10 while also facilitating charging of one or more batteries 114 disposed within housing 40. According to some embodiments, input device 14 further comprises an infrared transmitter 116 to facilitate wireless communications between input device 14 and electronic device 10.

Thus, embodiments of an electronic device docking system 12 are manufactured to provide an input device 14 removably coupleable within recessed area 38 disposed on top wall 26 of base member 20 that is usable while disposed within recessed area 38 or while removed from recessed area 38. Further, embodiments of an electronic device docking system 12 are manufactured to provide input interfaces 55 on input device 14 configured to provide input to electronic device 10 in a manner corresponding to a plurality of input interfaces 77 disposed on electronic device 10. Further, docking system 12 may be manufactured by providing a touch pad and a recessed area on a working surface of an electronic device where the recessed area is configured to receive a detachable input device. System 12 may also be manufactured by configuring the recessed area such that the input device is usable while disposed within the recessed area. System 12 may additionally be manufactured by providing a plurality of input interfaces each configured to provide input to the electronic device in a manner corresponding to a plurality of input interfaces disposed on the electronic device. System 12 may also be manufactured by providing a locking mechanism configured to releasably secure the input device to the electronic device. Moreover, system 12 may be manufactured by providing a connector member on the input device for communicative engagement with a corresponding connector member disposed on the electronic device, and by providing a retractable extension configured to releasably secure the input device to the electronic device. Thus, it should be understood that system 12 may be manufactured in a number of different manners.

What is claimed is:

1. An electronic device docking system, comprising:
an electronic device having a touch pad and a recessed area, the touch pad and recessed area disposed on a working surface of the electronic device, the recessed area configured to receive an input device.

2. The electronic device of claim 1, wherein the input device is usable while disposed within the recessed area.

3. The electronic device of claim 1, wherein the input device comprises a plurality of input interfaces each configured to provide input to the electronic device in a manner corresponding to a plurality of input interfaces disposed on the electronic device.

4. The electronic device of claim 1, wherein the input device comprises at least an alphanumeric keypad and a touch pad.

5. The docking system of claim 1, further comprising a locking mechanism configured to releasably secure the input device to the electronic device.

6. The docking system of claim 1, wherein the electronic device comprises a connector member for communicative engagement with a corresponding connector member disposed on the input device.

7. The docking system of claim 1, further comprising a retractable extension configured to secure the input device to the electronic device.

8. The docking system of claim 1, wherein the electronic device comprises an infrared transmitter to facilitate wirelessly communications between the input device and the electronic device.

9. A method of manufacturing a docking system for an electronic device, comprising:
providing a touch pad and a recessed area, the touch pad and recessed area on the electronic device disposed on a working surface of the electronic device, the recessed area configured to receive a detachable input device.

10. The method of claim 9, further comprising configuring the recessed area such that the input device is usable while disposed within the recessed area.

11. The method of claim 9, further comprising providing a plurality of input interfaces each configured to provide input to the electronic device in a manner corresponding to a plurality of input interfaces disposed on the electronic device.

12. The method of claim 9, further comprising providing at least an alphanumeric keypad and a touch pad on the input device.

13. The method of claim 9, further comprising providing a locking mechanism configured to releasably secure the input device to the electronic device.

14. The method of claim 9, further comprising providing a connector member on the input device for communicative engagement with a corresponding connector member disposed on the electronic device.

15. The method of claim 9, further comprising providing a retractable extension configured to releasably secure the input device to the electronic device.

16. An electronic device docking system, comprising:
an input device having at least two different input interfaces, the input device insertable within a recessed area disposed on a working surface of an electronic device, the at least two input interfaces configured to provide input to the electronic device in a manner corresponding to at least two input interfaces disposed on the electronic device.

17. The docking system of claim 16, wherein the at least two different input interfaces comprises at least two of a touch pad, an alphanumeric keypad and a plurality of media input buttons.

18. The docking system of claim 16, wherein the input device is usable while disposed within the recessed area.

19. The docking system of claim 16, further comprising a locking mechanism configured to releasably secure the input device to the electronic device.
